(19) United States
(12) Patent Application Publication
(10) Pub. No.: US 2015/0074114 A1
(43) Pub. Date: Mar. 12, 2015

(54) TAG MANAGEMENT DEVICE, TAG MANAGEMENT METHOD, TAG MANAGEMENT PROGRAM, AND COMPUTER-READABLE RECORDING MEDIUM FOR STORING SAID PROGRAM

(71) Applicant: Rakuten, Inc., Shinagawa-ku, Tokyo (JP)

(72) Inventor: Naoya Saito, Shinagawa-ku (JP)

(73) Assignee: Rakuten, Inc., Shinagawa-ku, Tokyo (JP)

(21) Appl. No.: 14/391,535

(22) PCT Filed: Nov. 2, 2012
(86) PCT No.: PCT/JP2012/078467

§ 371 Date: Oct. 9, 2014

(30) Foreign Application Priority Data
Apr. 27, 2012 (JP) 2012-103985

(51) Int. Cl. G06F 17/30

(52) U.S. Cl. CPC G06F 17/30598; G06F 17/30911
USPC 707/740

(57) ABSTRACT

A tag management device includes an acquisition unit, an evaluation unit and an output unit. The acquisition unit acquires a category of a target item. The evaluation unit extracts use information corresponding to the category of the target item from a storage unit that stores use information indicating use of a tag already assigned to an item, and evaluates a tag assignable to the target item based on the use information. The output unit outputs an evaluation result by the evaluation unit to a terminal of an offerer of the target item.

### TECHNICAL FIELD

One embodiment of the present invention relates to a device, a method, a program, and a computer-readable recording medium storing the program for managing the attributes of an item used for an item search as tags.

### BACKGROUND ART

Techniques to assign tags to an item displayed on a web site such as an online shopping site or an Internet auction site have been known. For example, in a search device disclosed in Patent Literature 1 below, item information is stored in association with a plurality of tag information indicating the attributes of the item, and the item information associated with the tag information is extracted in accordance with a search request. A tag serves as a key when searching for an item or narrowing down items, and thus a user can find a desired item using the tag.

### CITATION LIST

### Patent Literature

PTL 1: JP 2010-113390 A

### SUMMARY OF INVENTION

### Technical Problem

To allow a user to easily find a desired item, it is desirable to assign all of tags indicating the attributes of an item to the item. However, it takes efforts to choose a specific tag among a large number of tags, and tagging is a difficult task for a person who offers items on a web site (offerer). Accordingly, it is demanded to provide an offerer of items with information for making a decision for effective tagging to narrow down items.

### Solution to Problem

A tag management device according to one aspect of the present invention includes an acquisition unit configured to acquire a category of a target item, an evaluation unit configured to extract, from a storage unit configured to store use information indicating use of tags already assigned to items, the use information corresponding to the category of the target item, and evaluate a tag assignable to the target item based on the use information, and an output unit configured to output an evaluation result by the evaluation unit to a terminal of an offerer of the target item.

A tag management method according to one aspect of the present invention is a tag management method executed by a tag management device, the method including an acquisition step of acquiring a category of a target item, an evaluation step of extracting, from a storage unit storing use information indicating use of tags already assigned to items, the use information corresponding to the category of the target item, and evaluating a tag assignable to the target item based on the use information, and an output step of outputting an evaluation result in the evaluation step to a terminal of an offerer of the target item.

A tag management program according to one aspect of the present invention causes a computer to implement an acquisition unit configured to acquire a category of a target item, an evaluation unit configured to extract, from a storage unit configured to store use information indicating use of tags already assigned to items, the use information corresponding to the category of the target item, and evaluate a tag assignable to the target item based on the use information, and an output unit configured to output an evaluation result by the evaluation unit to a terminal of an offerer of the target item.

A computer-readable recording medium according to one aspect of the present invention stores a tag management program causing a computer to implement an acquisition unit configured to acquire a category of a target item, an evaluation unit configured to extract, from a storage unit configured to store use information indicating use of tags already assigned to items, the use information corresponding to the category of the target item, and evaluate a tag assignable to the target item based on the use information, and an output unit configured to output an evaluation result by the evaluation unit to a terminal of an offerer of the target item.

According to this aspect, use information corresponding to a category of a target item is extracted, a tag that can be assigned to the item is evaluated based on the use information, and a result of the evaluation is output to a terminal of an offerer of the target item. By evaluating the tag corresponding to the target item based on the use conditions of the tag already assigned to the item, it is possible to provide the offerer of the target item with information for making a decision for effective tagging to narrow down items.

In a tag management device according to another aspect of the present invention, the storage unit may further store tag basic information indicating a combination between a category of items and tags assignable to the category, and the evaluation unit may set a tag indicated by the tag basic information corresponding to the category of the target item as a tag assignable to the target item, and evaluate the set tag based on the use information. By defining tags that can be assigned to the target item as the tag basic information in advance, it is possible to avoid output of evaluation on tags not related to the target item.

In a tag management device according to another aspect of the present invention, the use information may contain item information indicating a category of items and tags assigned to the items by offerers, and the evaluation unit may count the number of records of the item information corresponding to the category of the target item for each tag, and evaluate a tag with the counted value being a specified threshold or less as a recommended tag. In this case, it is possible to recommend the tag that is rarely assigned by other offerers, which is, the tag with few rivals, to the offerer of the target item.

In a tag management device according to another aspect of the present invention, the use information may contain a search history indicating tags having been used for an item search by users, and the evaluation unit may count the number of records of the search history corresponding to the category of the target item for each tag, and evaluate a tag with the counted value being a specified threshold or more as a recommended tag. In this case, it is possible to recommend the tag that is used for searches by many users to the offerer of the target item.

In a tag management device according to another aspect of the present invention, the evaluation unit may extract a certain search history indicating that a search has been made during a period from a specified past point of time to present among the search history corresponding to the category of the target item, and count the number of records of the certain search history for each tag. In this case, it is possible to recommend the tag that has been used often in recent searches, which is the tag in which consumers are expected to be currently interested, to the offerer of the target item.

In a tag management device according to another aspect of the present invention, the use information may contain a purchase history indicating tags having led users to purchase an item, and the evaluation unit may count the number of records of the purchase history corresponding to the category of the target item for each tag, and evaluate a tag with the counted value being a specified threshold or more as a recommended tag. In this case, it is possible to recommend the tag that has led many users to purchase the item to the offerer of the target item.

In a tag management device according to another aspect of the present invention, the evaluation unit may extract a certain purchase history indicating that an item has been purchased during a period from a specified past point of time to present among the purchase history corresponding to the category of the target item, and count the number of records of the certain purchase history for each tag. In this case, it is possible to recommend the tag that has led many users to purchase the item recently, which is the tag in which consumers are expected to be currently interested, to the offerer of the target item.

In a tag management device according to another aspect of the present invention, the use information may contain a search history indicating tags having been used for an item search by users and a purchase history indicating tags having led users to purchase an item, and the evaluation unit may specify a tag having been used for a search but not been able to lead users to purchase the item based on the search history and the purchase history corresponding to the category of the target item, and evaluate a tag remaining after excluding the specified tag from the tags indicated by the search history as a recommended tag. In this case, it is possible to exclude the tag that causes users to lose their interests during the process from search to purchase from the target of recommendation.

In a tag management device according to another aspect of the present invention, the tag may be organized in a tree structure, and the evaluation unit may perform evaluation based on the use information for not only a tag in n-th hierarchical level indicated by the use information but also for each tag in a higher hierarchical level, where n>1. In this case, it is possible to evaluate the tag that is placed in an intermediate hierarchical level as well, and it is thus possible to present a larger number of recommended tags to the offerer of the target item.

In a tag management device according to another aspect of the present invention, the acquisition unit may receive the category of the target item from a terminal of the offerer trying to assign a tag to the target item. In this case, it is possible to provide the offerer who is trying to perform tagging with information for making a decision for that work.

In a tag management device according to another aspect of the present invention, the use information may contain item information indicating a category of items and tags assigned to the items by offerers, and the acquisition unit may acquire the category of the item indicated by the item information as the category of the target item. In this case, it is possible to prompt an offerer of an item to review the tag already assigned to the item. As a result, the offerer can find more suitable tags for the item and change the tag.

### Advantageous Effects of Invention

According to one aspect of the present invention, it is possible to provide an offerer of items with information for making a decision for tagging effective to narrow down items.

### BRIEF DESCRIPTION OF DRAWINGS

FIG. 1 is a diagram showing an overall configuration of a tag management system according to an embodiment.

FIG. 2 is a diagram showing one example of an item search screen of an EC site.

FIG. 3 is a diagram showing an example of tag basic information.

FIG. 4 is a diagram showing an example of item information.

FIG. 5 is a diagram showing an example of a search history.

FIG. 6 is a diagram showing an example of a purchase history.

FIG. 7 is a diagram showing a hardware configuration of a tag management server shown in FIG. 1.

FIG. 8 is a block diagram showing a functional configuration of the tag management server shown in FIG. 1.

FIG. 9 is a sequence chart showing presentation of recommended tags on the basis of a request from a shop.

FIG. 10 is a diagram showing an example of a management screen displayed on a shop terminal shown in FIG. 1.

FIG. 11 is a sequence chart showing presentation of recommended tags by batch processing.

FIG. 12 is a flowchart showing details of setting of recommended tags in FIGS. 9 and 11.

FIG. 13 is a diagram showing a configuration of a tag management program according to an embodiment.

### DESCRIPTION OF EMBODIMENTS

An embodiment of the present invention is described hereinafter in detail with reference to the appended drawings. Note that, in the description of the drawings, the same or equivalent elements are denoted by the same reference symbols, and the redundant explanation thereof is omitted.

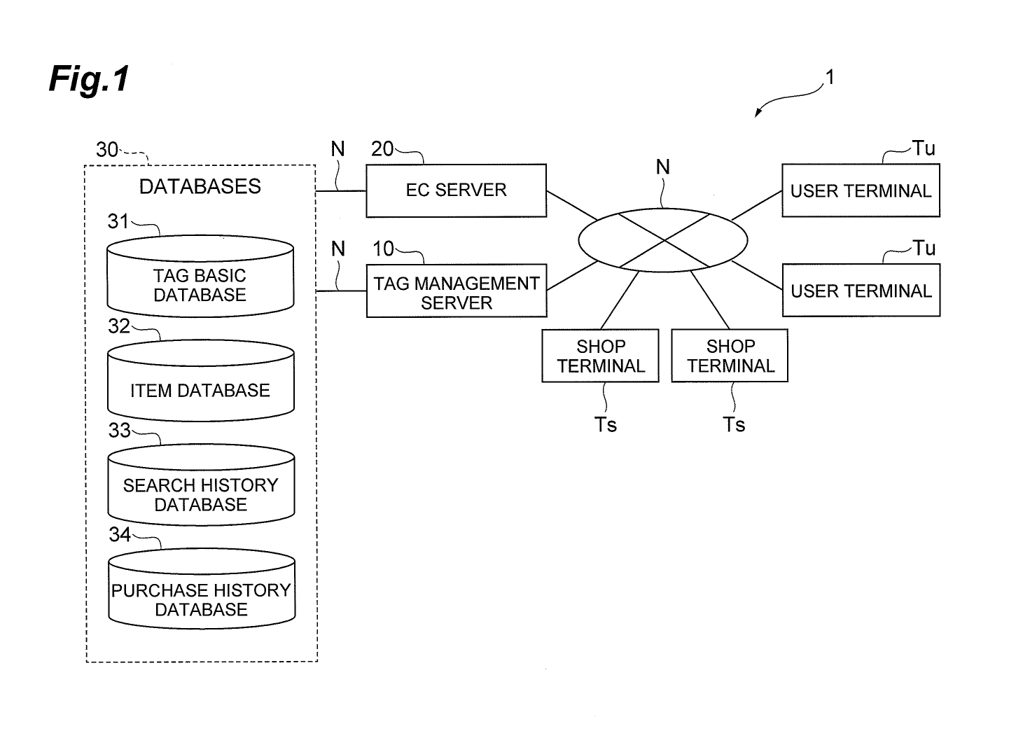

First, the functions and configuration of a tag management system 1 according to an embodiment are described hereinafter with reference to FIGS. 1 to 8. The tag management system 1 is a computer system that manages tags which are used for item searches in an EC site (online shopping site). As shown in FIG. 1, the tag management system 1 includes a tag management server (tag management device) 10, an EC server 20, databases 30, a shop terminal Ts, and a user terminal Tu. Those devices are connected with one another through a communication network N including the Internet, intranet or the like.

A tag is information indicating an attribute that is used as a search key among item attributes. A tag is assigned to an item by a manager of a virtual shop (shop manager). Because an association between an item and a tag is left to the discretion of a shop manager, there can be an item to which no tag is assigned.

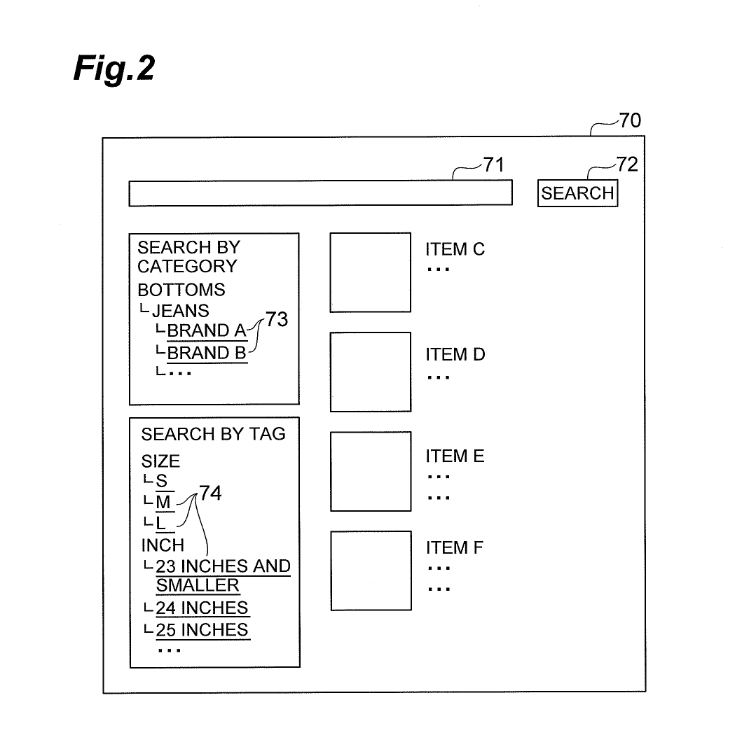

Because an association is made between an item and a tag, a user can use a tag search in addition to a keyword search and a category (genre) search when searching for an item on an EC site. For example, on a screen (web page) 70 as shown in FIG. 2, a user enters a keyword in a text box 71 and presses a search button 72 and can thereby find items matching the keyword. Further, a user clicks on a link 73 of a category or a link 74 of a tag and can thereby find items corresponding to the clicked category or link.

A category is an attribute indicating a group of items, and therefore both of a tag and a category are ones of item attributes. However, while one item can belong to only one category, a plurality of tags can be assigned to one item. In other words, the way of association with an item is different between a tag and a category. Note that an item attribute that is set as a category or a tag is not particularly limited.

The tag management server 10 is a computer system that supports tagging by a shop manager (an offerer of an item). To be more specific, the tag management server 10 notifies tags that are effective in search or sales if assigned to an item as recommended tag to the manager. A shop manager can assign a tag to a certain item when initially introducing the item to their virtual shop or can change the tag of an item already available in the virtual shop, and the tag management server 10 can support tagging in both cases.

The EC server 20 is a computer system that executes presentation of various web pages (for example, a main page, an item page, a shop page etc.) in an EC site, item searches, purchase processing (including stock update, payment, point award etc.) and the like in response to a request from the user terminal Tu. As described earlier, the EC server 20 provides users with a keyword search, a category search and a tag search as a means of item searches.

The databases 30 are a group of various kinds of databases required in the tag management system 1.

The shop terminal Ts is a computer owned by a manager of a shop joining a virtual shopping mall. The variety of the shop terminal Ts is not particularly limited, and it may be a stationary or portable personal computer, or a mobile terminal such as an advanced mobile phone (smart phone), a cellular phone or a personal digital assistant (PDA), for example. The number of shop terminals Ts in the tag management system 1 is not limited.

The user terminal Tu is a computer owned by a user (consumer). Just like the shop terminal Ts, the variety of the user terminal Tu is not particularly limited, and it may be a stationary or portable personal computer, or a mobile terminal such as an advanced mobile phone (smart phone), a cellular phone or a personal digital assistant (PDA), for example. The number of user terminals Tu in the tag management system 1 is also not limited.

On the assumption of the above, the tag management server 10 is described hereinafter in detail. First, various databases that are accessed by the tag management server 10 are described in detail.

A tag basic database 31 is a device that stores tag basic information indicating a list of tags that can be assigned to items belonging to a certain category. The tag basic information is information in which a category of items and tags that can be specified in the category are associated with each other. The tag basic information is registered in advance by an administrator of an EC site.

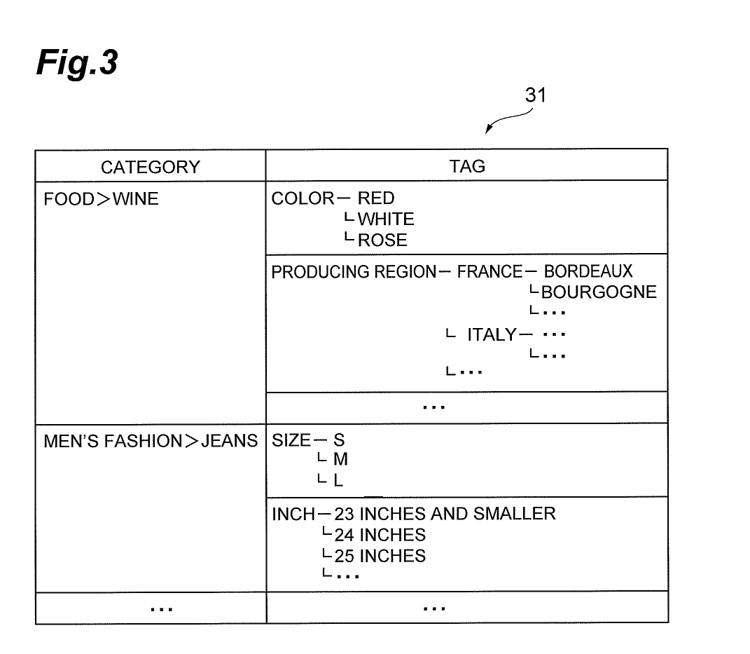

FIG. 3 shows an example of tag basic information. In FIG. 3, as the tags of the category “food>wine”, tags related to a color and tags related to a producing region are registered. Further, as the tags of the category “men's fashion>jeans”, tags related to a size and tags related to an inch are registered. The “food>wine” means a category where the first hierarchical level is “food” and the second hierarchical level is “wine”. Although the tag is represented in the form of a tree structure in FIG. 2, when it is represented in the same manner as the category, the tags related to a color in the category “food>wine” are represented as “color>red”, “color>white” and “color>rose”. Hereinafter, the representation using an inequality sign is used also for tags.

As shown in FIG. 3, each of the categories and tags is organized in a hierarchical (tree-structured) system in this embodiment, and the depth of the hierarchy is not limited for both of the categories and tags. For example, the categories may be organized in three or more hierarchical levels, or the tags may be organized in four or more hierarchical levels. Further, it is not necessary to define the categories and tags in a hierarchical manner.

An item database 32 is a device that stores item information related to items that are sold by each virtual shop. Each record of the item information contains a shop ID of a virtual shop that offers the item, an item ID that uniquely identifies the item and attribute information that indicates each attribute of the item. The attribute information contains the name, category, price, quantity of stock, tag, and URL of the item page of the item, though information contained in the attribute information is not limited. In this embodiment, the date and time when the tag is registered by the shop is also recorded in the item information as one of the item attributes. Because tagging is left to the discretion of a virtual shop as described above, there can be item information with no tag. The item information is initially registered, updated or deleted based on an instruction transmitted from the shop terminal Ts.

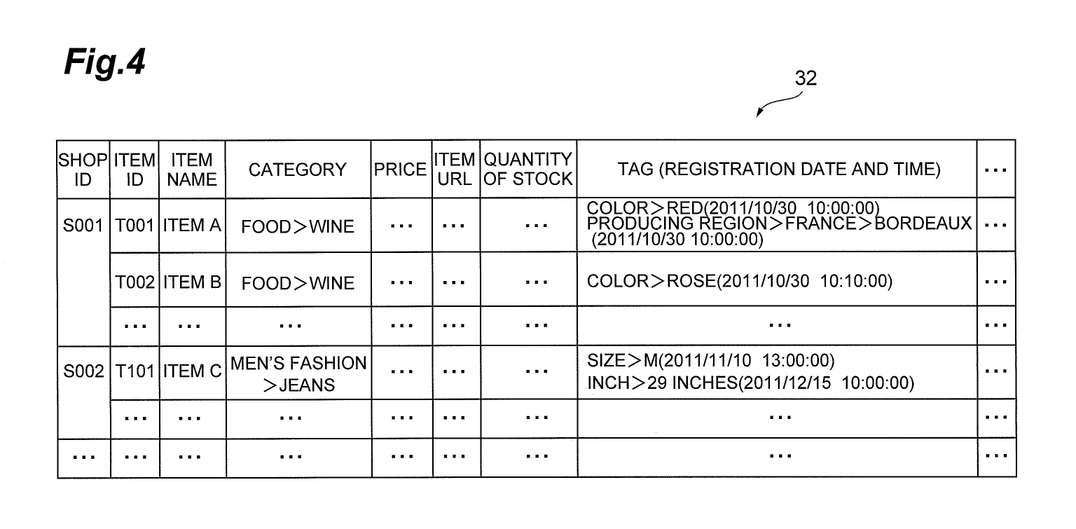

FIG. 4 shows an example of item information. In this example, “item A” with the item ID “T001” and “item B” with the item ID “T002” are associated with the shop ID “S001”. Further, “item C” with the item ID “T101” is associated with the shop ID “S002”. A plurality of tags are associated with the items A and C, whereas only one tag is associated with the item B. Because a tag of an item can be changed at any point, the registration date and time of a plurality of tags assigned to one item can be different from each other as in the item C.

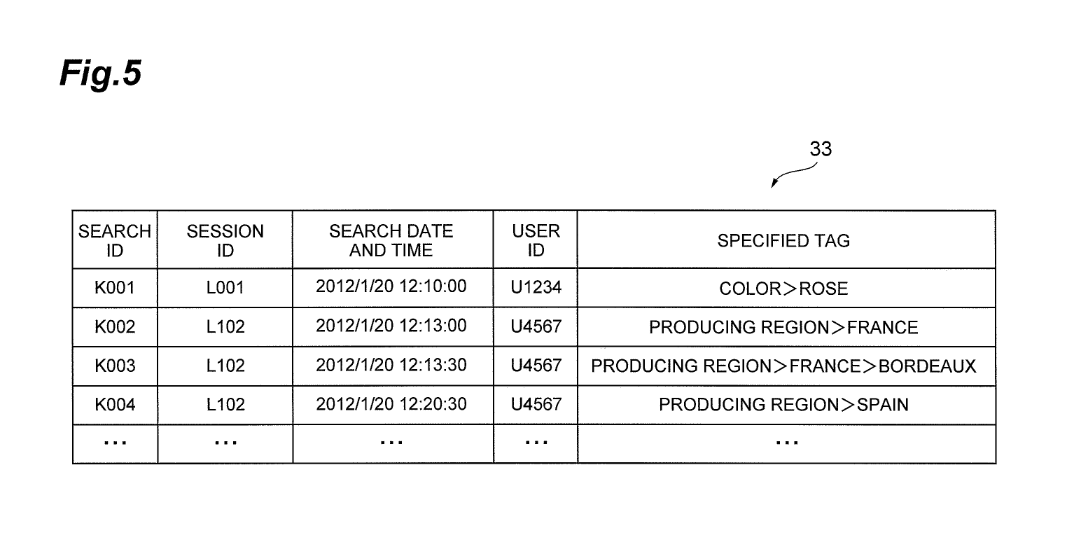

A search history database 33 is a device that stores a search history of a user in an EC site. Particularly, in this embodiment, the search history database 33 stores a tag search history. As shown in FIG. 5, each record of the search history contains a search ID that uniquely identifies each search processing, a session ID that identifies a session (one-time connection) between the user terminal Tu and the EC server 20, a search date and time, a user ID of a searcher, and a tag specified as a search key by the searcher. Each record of the search history is generated by the EC server 20 each time an item search is done by specifying one tag in the EC server 20. For example, when the same user makes search, moving down to a lower hierarchical level of a tag, as shown in the records with the search ID “K002” and “K003” of FIG. 5, a record is created at each level.

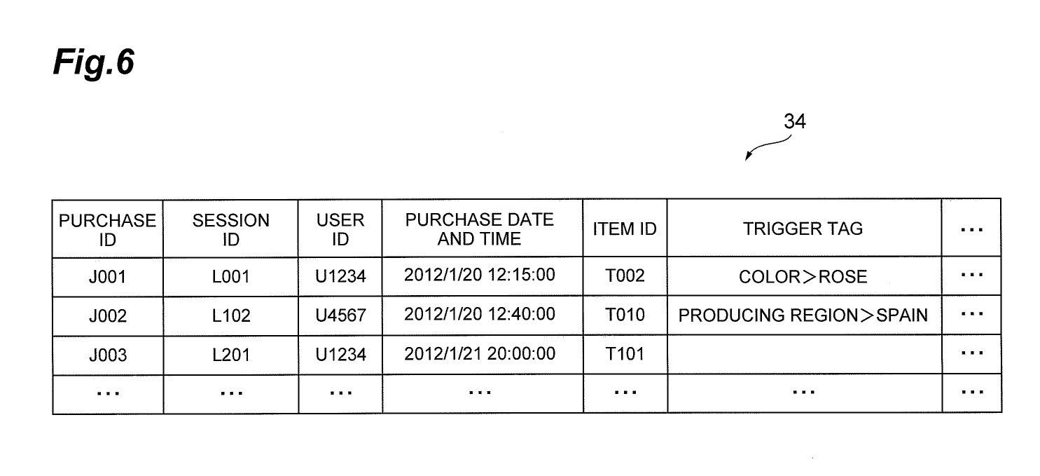

A purchase history database 34 is a device that stores a purchase history of a user in an EC site. As shown in FIG. 6, each record of the purchase history contains a purchase ID that uniquely identifies each purchase processing, a session ID, a user ID of a purchaser, a purchase date and time, an item ID of an item purchased, and a trigger tag. The trigger tag is a tag that is presumed that a search by the tag has been a trigger for purchase of an item, that is, a tag that has led a user to purchase an item. Like the record of the purchase ID “J003” in FIG. 6, there can be a purchase history to which no trigger tag is set. Each record of the purchase history is generated by the EC server 20 each time processing of one purchase procedure is done in the EC server 20. This record can contain other information such as a purchase price; however, a description of the other information that is not directly related to tag management is not given herein.

A method of determining whether a tag used in a tag search is the trigger tag or not is not limited. For example, when a link to an item that is displayed on a result page of a search by a tag G is clicked on to go to an item page, and the item is added to a shopping cart by a user operation on the item page and a purchase procedure is done, the tag G can be set as the trigger tag. On the other hand, when, after a result page of a search by a tag G is displayed, a user further conducts a search by another tag, a keyword search or a category search and the further search becomes a trigger for a purchase procedure, the tag G is not set as the trigger tag corresponding to the purchase procedure.

Note that the structure of each database and each record described above is not limited to those shown in FIGS. 3 to 6, and each database may be normalized or made redundant by an arbitrary policy. For example, a search history and a purchase history may be integrated by a session ID.

Note that the databases 30 include a user database that stores user information (member information), a shop database that stores shop information and the like; however, those databases that are not directly related to tag management are not described in detail.

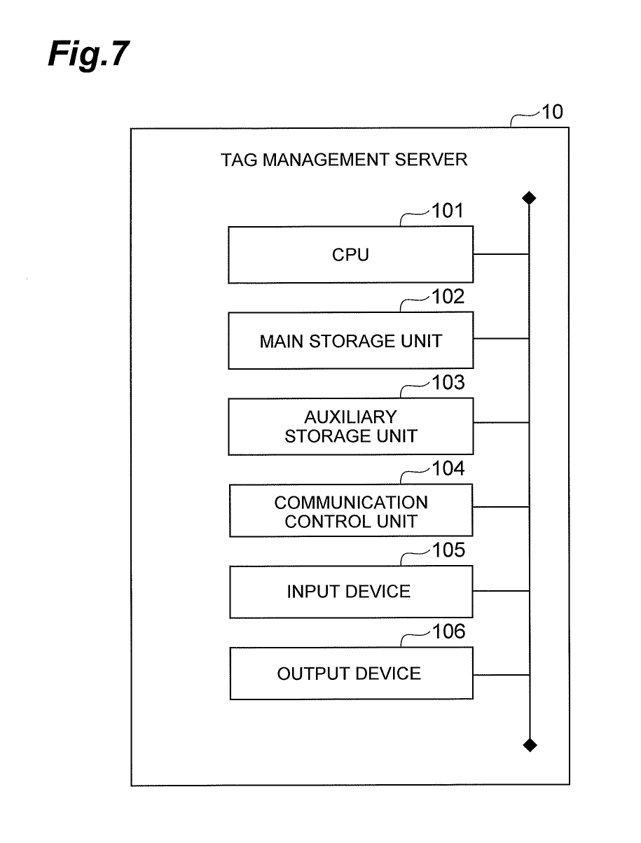

The function and configuration of the tag management server 10 are described hereinafter. FIG. 7 shows a hardware configuration of the tag management server 10. As shown therein, the tag management server 10 includes a CPU 101 that executes an operating system, an application program and the like, a main storage unit 102 such as ROM and RAM, an auxiliary storage unit 103 such as a hard disk, a communication control unit 104 such as a network card, an input device 105 such as a keyboard and a mouse, and an output device 106 such as a display.

The functional components of the tag management server 10, which are described later, are implemented by loading given software onto the CPU 101 or the main storage unit 102, making the communication control unit 104, the input unit 105, the output unit 106 and the like operate under control of the CPU 101, and performing reading and writing of data in the main storage unit 102 or the auxiliary storage unit 103. The data and database required for processing are stored in the main storage unit 102 or the auxiliary storage unit 103. Note that, although the tag management server 10 is composed of one computer in the example of FIG. 7, the functions of the tag management server 10 may be distributed among a plurality of computers.

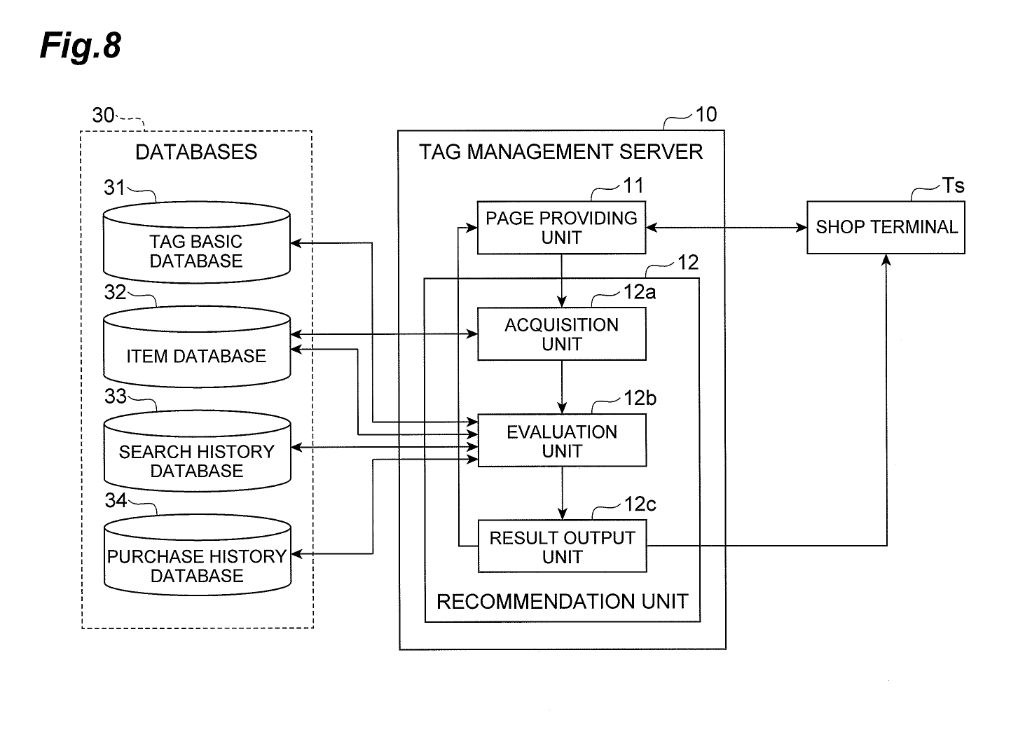

As shown in FIG. 8, the tag management server 10 includes a page providing unit 11 and a recommendation unit 12 as functional components. When a shop manager actively accesses a management screen at the time of initially registering an item or changing the tag of a registered item, the tag management server 10 may provide information of effective tags (which is referred to hereinafter as “recommendation information”) to the shop manager. In this case, the page providing unit 11 and the recommendation unit 12 operate. Alternatively, the tag management server 10 may check the item information in the item database 32 at arbitrary timing without an explicit request from the shop manager and provide recommendation information to the shop manager based on a result of the checking. In the case of this batch processing, only the recommendation unit 12 operates. In this specification, an item for which recommendation information is provided is referred to also as “target item”.

The page providing unit 11 is a functional component that provides a management screen for assigning a tag to an item to a shop manager. When the shop manager performs an operation to request the management screen on the shop terminal Ts, the shop terminal Ts transmits a page request containing the URL (Uniform Resource Locator) of the screen to the tag management server 10. The page providing unit 11 receives the request, generates a web page of the management screen and transmits it to the shop terminal Ts. After that, when the shop terminal Ts transmits a request for recommendation for obtaining recommendation information in response to an operation of the shop manager through the management screen, the page providing unit 11 receives the request and outputs it to the recommendation unit 12. The request for recommendation contains the category of a target item for which the shop manager intends to assign a tag or change the tag.

The recommendation unit 12 is a functional component that presents tags that are effective for item search or sales to a shop manager. The recommendation unit 12 includes an acquisition unit 12a, an evaluation unit 12b, and a result output unit 12c.

The acquisition unit 12a is a functional component that acquires information of a target item that is required to recommend tags. In the case where a request for recommendation is acquired from the page providing unit 11, the acquisition unit 12a acquires the category contained in the request as target item information. In the case of batch processing, the acquisition unit 12a acquires a record of item information (specifically, one or more sets of an item ID and a category) as the target item information from the item database 32. The acquisition unit 12a outputs the acquired target item information to the evaluation unit 12b.

The evaluation unit 12b is a functional component that extracts use information corresponding to the target item information input from the acquisition unit 12a from the databases 30 and evaluates tags that can be assigned to the target item based on the use information. The use information is information indicating use of the tag already assigned to the item and, in this embodiment, the item information, the search history and the purchase history correspond to the use information. The item information indicates that a shop manager has assigned a tag to an item in order to represent the feature of the item, and therefore it is the use information indicating use of the tag by the shop manager. The search history and the purchase history indicate that a user has used a tag (for example, has clicked on a tag) when searching for or purchasing an item, and therefore it is the use information as well.

The evaluation unit 12b specifies tags that are effective for each target item indicated by the input target item information based on the use information. The evaluation unit 12b may perform the processing in various ways as described below.

[Processing Based on Item Information]

The evaluation unit 12b specifies one or more tags (which are hereinafter referred to also as “candidate tags”) that can be assigned to a target item by extracting the tag basic information corresponding to the category (hereinafter referred to also as “target category”) of the target item from the tag basic database 31. Next, the evaluation unit 12b extracts the item information corresponding to the target category from the item database 32. The evaluation unit 12b then counts the number of records of the extracted item information for each candidate tag and thereby specifies the number of shops where each tag is used. Then, the evaluation unit 12b sets the candidate tags for which the counted number of records is a specified threshold Ta or less as the recommended tags. The threshold Ta may be set arbitrarily, such as Ta=1 or Ta=10. This processing is performed with a view to recommend the tags that are rarely assigned in other shops, which is, the tags with few rivals.

Alternatively, the evaluation unit 12b extracts the item information corresponding to the target category and where the tag registration date and time are after a specified point of time in the past (for example, during the last one month or the last one year etc.) from the item database 32. This means that the evaluation unit 12b extracts only some records where the tag has been registered or updated recently among the item information corresponding to the target category. The evaluation unit 12b then counts the number of extracted records for each candidate tag and thereby specifies the number of shops where each tag is used. Then, the evaluation unit 12b sets the candidate tags for which the counted number of records is a specified threshold Tb or more as the recommended tags. The threshold Tb may be set arbitrarily, such as Tb=10 or Tb=50. This processing is performed with a view to recommend the tags that have been assigned in many shops recently, which is, the tags that are likely to get customers' attention at the present moment.

[Processing Based on a Search History]

The evaluation unit 12b specifies one or more candidate tags from the target category in the same manner as above, and extracts the search history corresponding to the candidate tag from the search history database 33. Next, the evaluation unit 12b counts the number of records of the extracted search history for each candidate tag and thereby specifies the number of searches where each tag is used. Then, the evaluation unit 12b sets the candidate tags for which the counted number of records is a specified threshold Tc or more as the recommended tags. The threshold Tc may be set arbitrarily, such as Tc=100 or Tc=1000. This processing is performed with a view to recommend the tags that are used by many users for search.

In the extraction of a search history, the evaluation unit 12b may extract only the search history that meets the additional conditions that the search date and time are after a specified point of time in the past (for example, during the last one month or the last one year etc.). The subsequent processing is the same as above. In this case, it is possible to recommend the tags that have been used often in recent searches, which is the tags in which consumers are expected to be currently interested.

[Processing Based on a Purchase History]

The evaluation unit 12b specifies one or more candidate tags from the target category in the same manner as above, and extracts the purchase history corresponding to the candidate tag from the purchase history database 34. Next, the evaluation unit 12b counts the number of records of the extracted purchase history for each candidate tag and thereby specifies the number of times each tag has served as a trigger for purchase of the item. Then, the evaluation unit 12b sets the candidate tags for which the counted number of records is a specified threshold Td or more as the recommended tags. The threshold Td may be set arbitrarily, such as Td=10 or Td=50. This processing is performed with a view to recommend the tags that have led many users to purchase the item.

In the extraction of a search history, the evaluation unit 12b may extract only the purchase history that meets the additional conditions that the purchase date and time are after a specified point of time in the past (for example, during the last one month or the last one year etc.). The subsequent processing is the same as above. In this case, it is possible to recommend the tags that have led many users to purchase the item recently, which is the tags in which consumers are expected to be currently interested.

[Processing Based on a Search History and a Purchase History]

The evaluation unit 12b specifies one or more candidate tags from the target category in the same manner as above, and extracts the search history and the purchase history corresponding to the candidate tag from the search history database 33 and the purchase history database 34. Next, the evaluation unit 12b associates the search history and the purchase history having the same session ID and compares tag specified in a search with the trigger tag to thereby specify the tag that has been used for a search but a sale is made as a result of a later search with another tag. This means to specify the tags that have not been able to lead a user to purchase the item in the end.

In the examples of FIGS. 5 and 6, as for the session ID “L001”, the tag “color>rose” specified at the time of a search is the trigger tag, and therefore this tag is presumed to be effective for sales. On the other hand, as for the session ID “L102”, the two tags “producing region>France” and “producing region>France>Bordeaux” are both different from the trigger tag, and therefore those tags are presumed to be not effective for sales.

Then, the evaluation unit 12b sets the tags that remain after excluding the specified tags (for example, the tags such as “producing region>France” and “producing region>France>Bordeaux” in the examples of FIGS. 5 and 6) from the tags indicated by the extracted search history as the recommended tags. It is thereby possible to exclude the tags that cause users to lose their interests during the process from search to purchase from the target of recommendation.

[Processing Using Several Ones of the Above Four Methods]

The evaluation unit 12b may extract the recommended tags using any plural methods of the above-described four methods, rather than executing only one of the above four methods.

[Processing in Consideration of a Tag Tree Structure]

In the case where a tag is organized in a tree structure as in this embodiment, the evaluation unit 12b may evaluate not only the tag in the n-th hierarchical level (n>1) indicated by each type of the use information but also each tag in a higher hierarchical level as to whether it can be the recommended tag.

For example, as for the tag “producing region>France>Bordeaux” of the item A in FIG. 4, the evaluation unit 12b may count the number of records for the tag (the tag in the third hierarchical level) and further count the number of records for the tag in the second hierarchical level “producing region>France” and the number of records for the tag in the first hierarchical level “producing region”. As for the search tag and the trigger tag shown in FIGS. 5 and 6 as well, the evaluation unit 12b may count the number of records not only for the tag indicated by the search history or the purchase history but also for the parent tag.

Although the processing of extracting the recommended tags by comparing the counted number of records with a threshold is the same as above, the threshold may be different for each hierarchical level of the tag. For example, each threshold may be set in advance so that the threshold is smaller as the hierarchical level is lower. In this case, it is possible to evaluate the tag that is placed in an intermediate hierarchical level as well, and it is thus possible to present a larger number of recommended tags to a shop manager.

Although there are various methods for determining recommended tags, which are methods for evaluating tags, as described above, the evaluation unit 12b extracts recommended tags for each of the input target items and outputs information (recommendation information) of the recommended tags to the result output unit 12c in any case.

The result output unit 12c is a functional component that outputs the recommendation information input from the evaluation unit 12b as an evaluation result. In the case where evaluation processing is performed in response to an explicit request from a shop (management screen), the result output unit 12c outputs the recommendation information to the page providing unit 11 and, after that, the page providing unit 11 transmits the information to the shop terminal Ts. In this case, the recommendation information is displayed on the management screen. In the case where evaluation processing is performed by batch processing, the result output unit 12c transmits the recommendation information to the shop terminal Ts by a notification means such as E-mail.

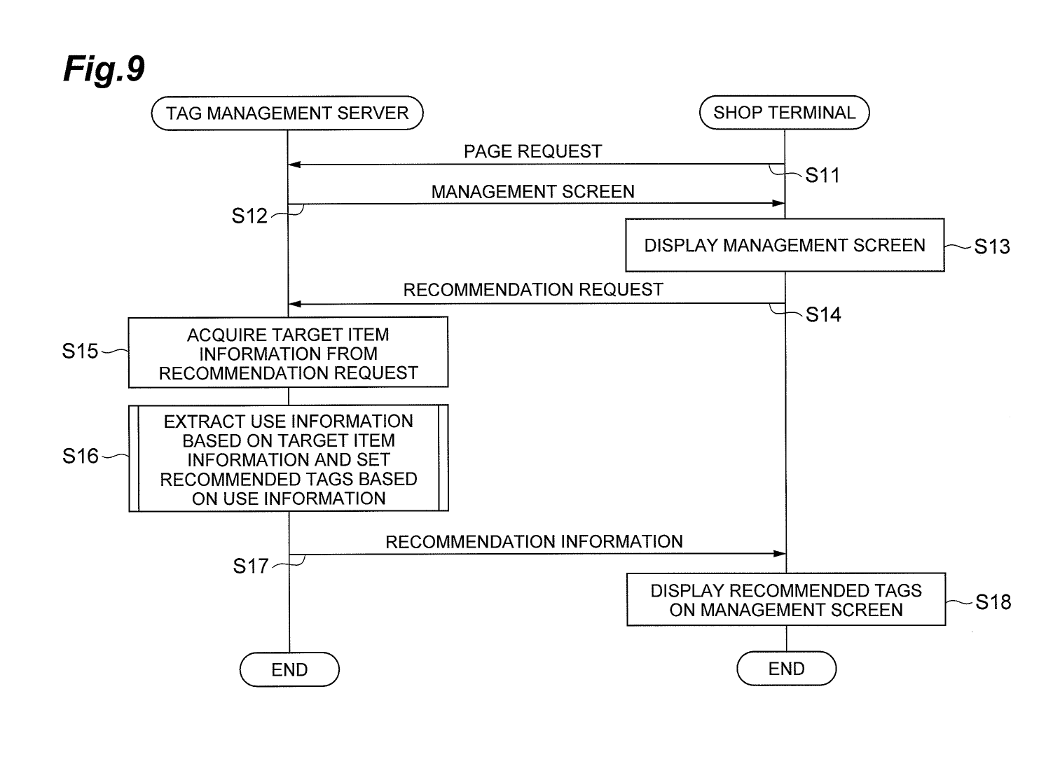

The operation of the tag management server 10 is described, and further, a tag management method according to this embodiment is described hereinafter with reference to FIGS. 9 to 12.

In the case of providing the recommendation information in response to an explicit request from a shop, the tag management server 10 operates as shown in FIG. 9. When the shop terminal Ts transmits a page request (Step S11), the page providing unit 11 in the tag management server 10 generates a web page of a management screen and transmits it to the shop terminal Ts (Step S12), and the shop terminal Ts displays the management screen (Step S13).

After that, the shop terminal Ts transmits a recommendation request to the tag management server 10 in response to a user operation on the management screen (Step S14), and then the page providing unit 11 in the tag management server 10 receives the request, and the acquisition unit 12a acquires target item information (target category) from the recommendation request (Step S15, acquisition step). Then, the evaluation unit 12b extracts use information based on the target item information, and sets recommended tags based on the use information (Step S16, evaluation step). After that, the result output unit 12c and the page providing unit 11 transmit the recommended tags as recommendation information to the shop terminal Ts (Step S17, output step).

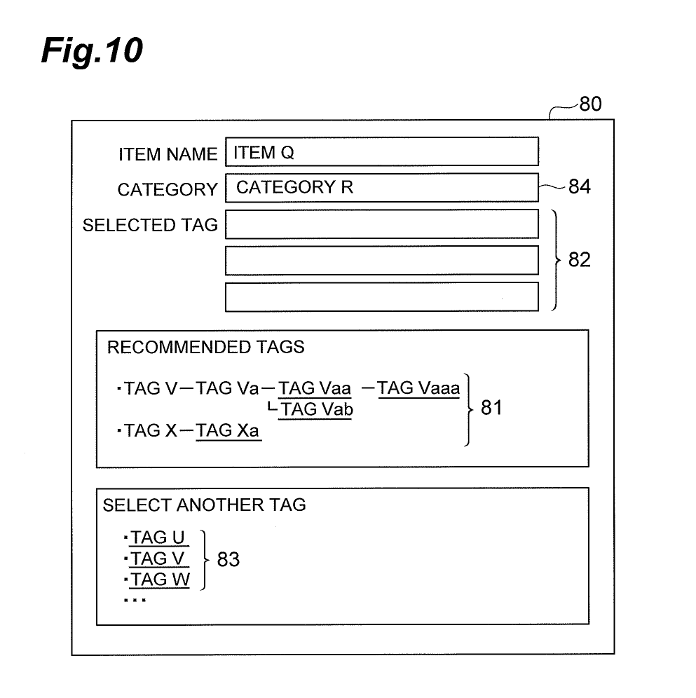

Then, the shop terminal Ts receives the recommendation information and displays the recommended tags on the management screen (Step S18). For example, as shown in FIG. 10, the shop terminal Ts displays a list 81 of the recommended tags in a tree structure on a management screen 80. In this example, the recommended tags are displayed as links, and when a shop manager clicks on the link, the corresponding recommended tag is displayed in a selected tag field 82.

In the example of FIG. 10, four recommended tags “tag V-tag Va-tag Vaa”, “tag V-tag Va-tag Vaa-tag Vaaa”, “tag V-tag Va-tag Vab” and “tag X-tag Xa” are shown. Note that the shop manager can select a tag other than the recommended tags. Specifically, the shop manager may select a desired tag from a list 83 of all tags that are set in a tree structure where a lower layer appears when clicked. The lists 81 and 83 are based on the tag basic information corresponding to the category entered in a category field 84.

In the case of providing the recommendation information by batch processing, the tag management server 10 operates as shown in

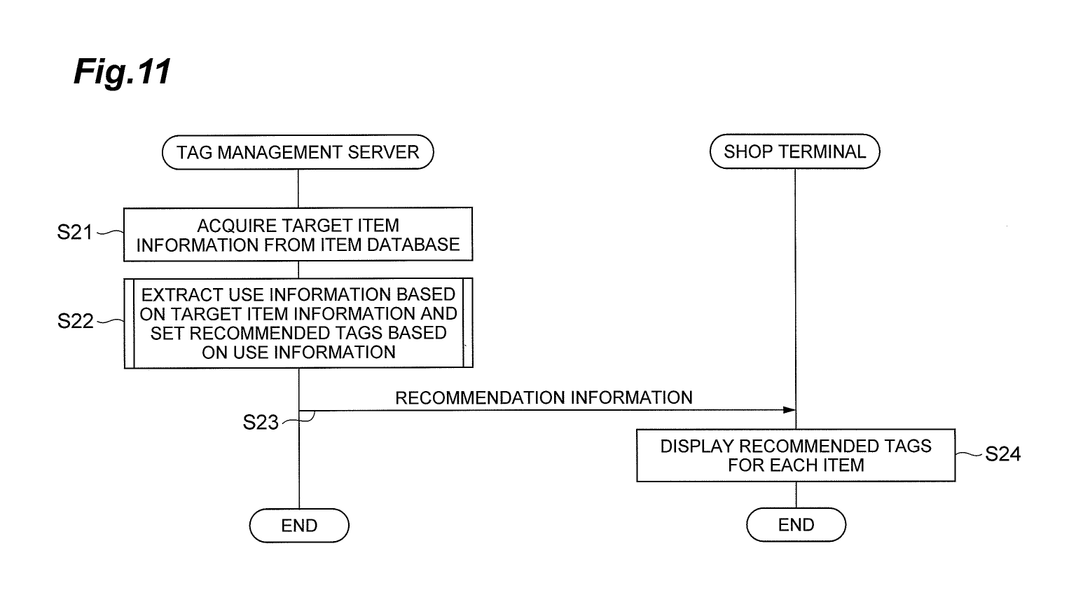

FIG. 11. First, the acquisition unit 12a acquires target item information (one or more sets of item ID and category) from the item database 32 (Step S21, acquisition step). Then, the evaluation unit 12b extracts use information based on the target item information, and sets recommended tags based on the use information (Step S22, evaluation step) in the same manner as the processing of Step S16 described above. After that, the result output unit 12c transmits the recommended tags as recommendation information to the shop terminal Ts (Step S23, output step). The shop terminal Ts receives the recommendation information and displays the recommended tags for each item on the screen by an arbitrary method (for example, in response to a user operation or by automatic display) (Step S24).

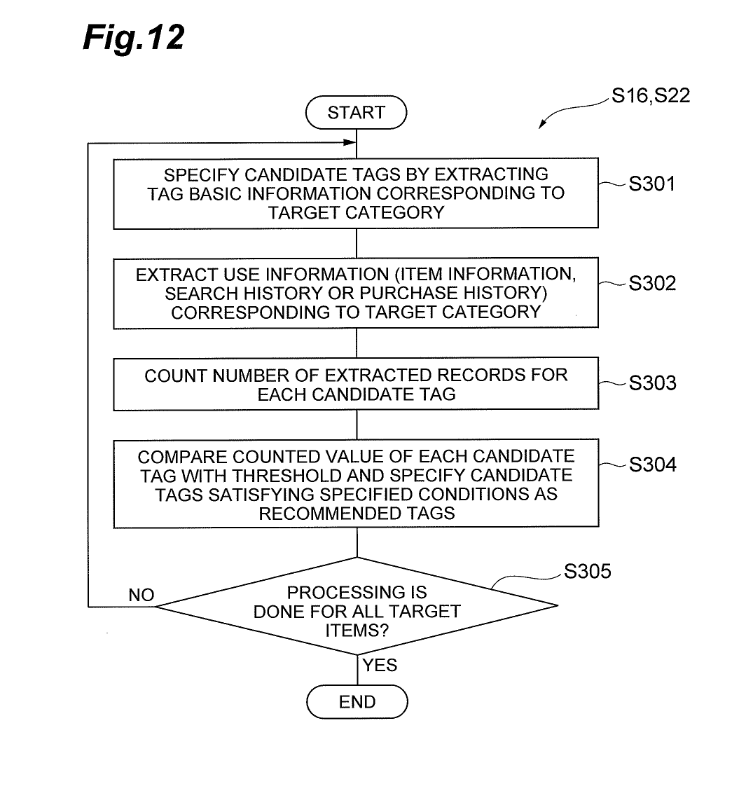

The details of the processing of the above-described Steps S16 and S22 are as shown in FIG. 12. The evaluation unit 12b first extracts the tag basic information corresponding to the target category and thereby specifies candidate tags (Step S301). Then, the evaluation unit 12b extracts use information (item information, search history or purchase history) corresponding to the target category (Step S302), and counts the number of extracted records for each of the candidate tags (Step S303). Then, the evaluation unit 12b compares the counted value of each candidate tag with a threshold (for example, any of the thresholds Ta to Td described above) and specifies the candidate tags that meet the specified conditions as described above as recommended tags (Step S304). The evaluation unit 12b performs the evaluation processing of Steps S301 to S304 for all target items (Step S305).

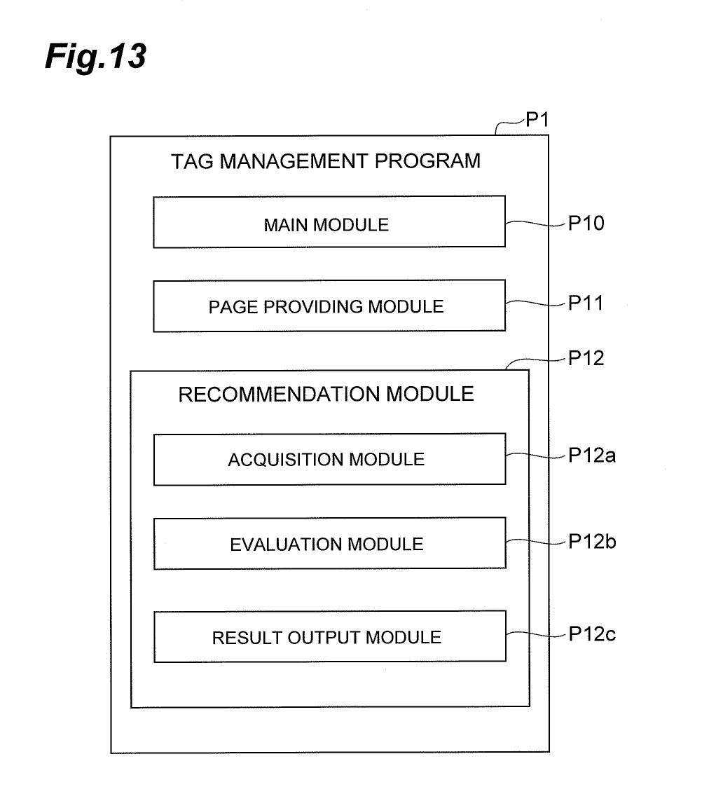

Hereinafter, a tag management program P1 for implementing the tag management server 10 is described with reference to FIG. 13.

The tag management program P1 includes a main module P10, a page providing module P 11 and a recommendation module P12. The recommendation module P12 includes an acquisition module P12a, an evaluation module P12b, and a result output module P12c.

The main module P10 is a part that exercises control over the tag management functions. The functions implemented by executing the page providing module P11, the recommendation module P12, the acquisition module P12a, the evaluation module P12b and the result output module P12c are equal to the functions of the page providing unit 11, the recommendation unit 12, the acquisition unit 12a, the evaluation unit 12b, and the result output unit 12c described above, respectively.

The tag management program P1 is provided in the form of being recorded in a static manner on a tangible recording medium such as CD-ROM or DVD-ROM or semiconductor memory, for example. Further, the tag management program P1 may be provided as a data signal superimposed onto a carrier wave through a communication network.

As described above, according to this embodiment, use information (item information, search history or purchase history) corresponding to the category of a target item is extracted, and tags that can be assigned to the item are evaluated based on the use information, and a result of the evaluation (recommendation information) is output to the shop terminal Ts. In this manner, by evaluating the tags corresponding to the target item based on the use conditions of the tags already assigned to the item, it is possible to provide a shop manager with information for making a decision for effective tagging to narrow down items. Then, if the shop manager assigns appropriate tags to the item based on the recommendation information, a user (consumer) can easily search for the item, thus enhancing the user-friendliness of the EC site.

In the case where a shop manager performs tagging through a management screen, it is possible to provide the manager with information for making a decision for that work at that time. In the case where recommendation information is transmitted to the shop terminal Ts by batch processing, it is possible to prompt a shop manager to review the tags already assigned to the item (the tags registered as one of item information). As a result, the manager can find more suitable tags for the item and change the tags.

Embodiments of the present invention are described in detail above. However, the present invention is not limited to the above-described embodiments. Various changes and modifications may be made to the present invention without departing from the scope of the invention.

Although the evaluation unit 12b specifies candidate tags by extracting tag basic information and then selects recommended tags from the candidate tags in the above-described embodiment, the evaluation unit 12b does not necessarily use the tag basic information (the tag basic database 31). In this case, the evaluation unit 12b extracts use information (item information, search history or purchase history) corresponding to the target category from the corresponding database, and counts the number of extracted records for each of the tags indicated by the use information to thereby specify the number of shops where each tag is used. Then, the evaluation unit 12b sets the tags for which the counted number of records meets the conditions on the basis of a specified threshold as the recommended tags.

In the above-described embodiment, the evaluation unit 12b evaluates tags that are presumed to be effective if assigned to an item as recommended tags, and the result output unit 12c outputs the tags as recommendation information. In addition to, or in place of, this processing, the evaluation unit 12b may evaluate tags that have not been selected as recommended tags as non-recommended tags, and the result output unit 12c may output the non-recommended tags. In this case, a shop manager can be informed of the tags that are not suitable to be assigned to the item.

The present invention is applicable not only to tagging of an item offered on an EC site but also to tagging of other items. For example, the support of tagging according to the present invention may be applied to processing for tagging when a person tries to sell items through an Internet auction.

### REFERENCE SIGNS LIST

1 . . . tag management system, 10 . . . tag management server, 11 . . . page providing unit, 12 . . . recommendation unit, 12a . . . acquisition unit, 12b . . . evaluation unit, 12c . . . result output unit, 20 . . . EC server, 30 . . . databases, 31 . . . tag basic database, 32 . . . item database, 33 . . . search history database, 34 . . . purchase history database, P1 . . . tag management program, P10 . . . main module, P11 . . . page providing module, P12 . . . recommendation module, P12a . . . acquisition module, P12b . . . evaluation module, P12c . . . result output module, Ts . . . shop terminal, Tu . . . user terminal

1. A tag management device comprising:
an acquisition unit configured to acquire a category of a target item from a terminal of an offerer trying to assign a tag to the target item;
an evaluation unit configured to extract, from a storage unit configured to store use information containing at least one of an assignment history indicating assignment of tags to items and a use history of tags already assigned to items, the use information corresponding to the category of the target item, and extract a recommended tag from a tag assignable to the target item based on the use information; and
an output unit configured to output information of the recommended tag extracted by the evaluation unit to the terminal of the offerer.

2. The tag management device according to claim 1, wherein
the storage unit further stores tag basic information indicating a combination between a category of items and tags assignable to the category, and
the evaluation unit sets a tag indicated by the tag basic information corresponding to the category of the target item as a tag assignable to the target item, and extracts the recommended tag from the set tag based on the use information.

3. The tag management device according to claim 1, wherein
the use information contains information indicating a category of each of a plurality of items and tags assigned to the items by offerers as the assignment history, and
the evaluation unit counts the number of records of the assignment history corresponding to the category of the target item for each tag, and extracts a tag with the counted value being a specified threshold or less as the recommended tag.

4. The tag management device according to claim 1, wherein
the use information contains a search history indicating tags having been used for an item search by users as the use history, and
the evaluation unit counts the number of records of the search history corresponding to the category of the target item for each tag, and extracts a tag with the counted value being a specified threshold or more as the recommended tag.

5. The tag management device according to claim 4, wherein
the evaluation unit extracts a certain search history indicating that a search has been made during a period from a specified past point of time to present among the search history corresponding to the category of the target item, and counts the number of records of the certain search history for each tag.

6. The tag management device according to claim 1, wherein
the use information contains a purchase history indicating tags having led users to purchase an item as the use history, and
the evaluation unit counts the number of records of the purchase history corresponding to the category of the target item for each tag, and extracts a tag with the counted value being a specified threshold or more as the recommended tag.

7. The tag management device according to claim 6, wherein
the evaluation unit extracts a certain purchase history indicating that an item has been purchased during a period from a specified past point of time to present among the purchase history corresponding to the category of the target item, and counts the number of records of the certain purchase history for each tag.

8. The tag management device according to claim 1, wherein
the use information contains a search history indicating tags having been used for an item search by users and a purchase history indicating tags having led users to purchase an item as the use history, and
the evaluation unit specifies a tag having been used for a search but not been able to lead users to purchase the item based on the search history and the purchase history corresponding to the category of the target item, and extracts a tag remaining after excluding the specified tag from the tags indicated by the search history as the recommended tag.

9. The tag management device according to claim 1, wherein
the tag is organized in a tree structure, and
the evaluation unit extracts the recommended tag, based on the use information, not only from a tag in n-th hierarchical level indicated by the use information but also from each tag in a higher hierarchical level, where n>1.

10. (canceled)

11. The tag management device according to claim 1, wherein
the use information contains item information indicating a category of each of a plurality of items and tags assigned to the items by offerers as the assignment history, and
the acquisition unit acquires the category of the item indicated by the assignment history as the category of the target item.

12. A tag management method executed by a tag management device, the method comprising:
an acquisition step of acquiring a category of a target item from a terminal of an offerer trying to assign a tag to the target item;
an evaluation step of extracting, from a storage unit storing use information containing at least one of an assignment history indicating assignment of tags to items and a use history of tags already assigned to items, the use information corresponding to the category of the target item, and extracting a recommended tag from a tag assignable to the target item based on the use information; and
an output step of outputting information of the recommended tag extracted in the evaluation step to the terminal of the offerer.

13. (canceled)

14. A non-transitory computer-readable recording medium storing a tag management program causing a computer to implement:
an acquisition unit configured to acquire a category of a target item from a terminal of an offerer trying to assign a tag to the target item;
an evaluation unit configured to extract, from a storage unit configured to store use information containing at least one of an assignment history indicating assignment of tags to items and a use history of tags already assigned to items, the use information corresponding to the category of the target item, and extract a recommended tag from a tag assignable to the target item based on the use information; and
an output unit configured to output information of the recommended tag extracted by the evaluation unit to the terminal of the offerer.
